(19) United States
(12) Patent Application Publication
(10) Pub. No.: US 2026/0304032 A1
(43) Pub. Date: Oct. 1, 2026

(54) SPEAKER ENCLOSURE WITH SOUNDWAVE SHAPING

(71) Applicant: Danley Sound Labs, Inc., Gainesville, GA (US)

(72) Inventor: Thomas J. DANLEY, Dahlonega, GA (US)

(73) Assignee: Danley Sound Labs, Inc., Gainesville, GA (US)

(21) Appl. No.: 19/422,102

(22) Filed: Dec. 16, 2025

Related U.S. Application Data
(60) Provisional application No. 63/737,291, filed on Dec. 20, 2024.

(51) Int. Cl. H04R 1/34; H04R 1/40

(52) U.S. Cl. CPC H04R 1/345; H04R 1/403

(57) ABSTRACT

A sound reproduction system is disclosed in which a sound enclosure has an inlet portion, a sound emission portion, and a baffle portion therebetween. The various portions are dimensioned and configured such that as the soundwaves travel through the baffle restriction portions and exits through the outlet ports, the soundwaves are forced to travel along equal length paths and thus are manipulated into behaving substantially as if they emanate from a line sound source or a more distant point source.

### CROSS-REFERENCE TO RELATED APPLICATIONS

The present application claims the priority benefit of U.S. Provisional Patent Application Ser. No. 63/737,291, filed on Dec. 20, 2024, the entirety of which is hereby incorporated by reference.

### FIELD OF THE INVENTION

The present invention relates to sound reproduction systems in which one or more drivers, mutually coupled to a sound enclosure, have their combined three-dimensional waveshape altered within the enclosure to a preselected exit waveshape.

### DESCRIPTION OF THE RELATED ART

Originally, the art of horn loading of drivers was done to increase the electroacoustic efficiency of the drivers. Various techniques were employed early on to make the most of limited amplifier power and relatively low power handling capabilities of available drivers. Early efforts were centered around obtaining the greatest sound level possible. Horn loaded speakers, sometimes referred to simply as “horns” or “warning systems” of this early era were generally designed to have a specific expansion rate throughout, and typically were made to have a defined shape such as that of a simple cone as well as curved wall flares having shapes corresponding to exponential or hyperbolic curves. Typically, these designs were aimed at giving the best low-frequency performance.

Complementary horn/driver systems were developed for different frequency ranges to optimize the ability of a horn to confine the sound wave in a practical manner. The design of relatively low frequency horns encountered challenging problems because of the mass and acoustic size required, and because the ability of a horn to confine the sound to a given angle diminishes below some frequency defined by the wavelength being produced for horns having a practical wall angle and dimension. For practical horns, a frequency inevitably arises where, due to practical dimensional considerations, the horn loses the ability to control the radiation angle of the soundwave being guided by the enclosure.

As noted above, one practical challenge faced by loudspeaker systems of all types is the ability to deliver a minimum desired sound pressure level to the listener's environment. Over the years, certain fundamental types of loudspeaker systems have been recognized for their inherent ability to deliver sound pressure levels. The two most popular types are those employing point source drivers (cones, domes, horns, multicellular panels, etc.). and line source drivers (e.g. ribbon drivers and elongated planar drivers). With point source drivers, sound is conceptualized as emanating from a single point, expanding in all directions, i.e. “spherically” (e.g. vertically, floor to ceiling and horizontally, side to side).

In contrast, a line source radiates sound in a cylindrical pattern. Sound travels outward from the driver in the shape of an expanding cylinder, bounded at its ends by flat, planar end planes, and not as an expanding sphere, as in the case of point sources. This confined soundwave pattern of a line source is inherently more efficient than that of a point source, since the expanding spherical sound energy of a point source is confined into the shape of an expanding cylinder, so as to “focus” or concentrate the same energy into a spatial region of reduced size.

Line sources may be characterized as a type of acoustic source which is acoustically large in one dimension (their length) but acoustically small in the other direction (cross-sectional dimension). Attempts have been made, for example, to emulate a line source by a linear arrangement of discrete sources. Despite some interesting results, improved systems are still being sought. One problem with such arrangements, for example, is the undesirable interaction of one point source with another that inevitably arises due to propagation effects arising in a practical system.

In prior attempts to create a line-like sound from a point-source is that different path lengths within the enclosure negatively impact the wavefront as it travels through and exits the enclosure. This creates uneven sound pressure levels along the wavefront. In a system using discrete sources the line source effect may be produced by constructive and destructive interference depending on the distance and angle.

Accordingly, non-line source sound reproduction systems which truly appear to be that of a line source are still being sought. Further, sound reproduction systems that allow convenient shaping of their exiting wavefront are also being sought.

### SUMMARY OF THE INVENTION

The present invention provides a novel and improved sound reproduction system in which a sound enclosure defines a soundwave path having a first end, a second open end and at least one bend therebetween. At least one driver is provided at the first end for producing a driver soundwave that is confined by the sound enclosure for travel along the soundwave path. At least one baffle member is situated in the soundwave path, defining a redirecting surface (or surfaces) of preselected shape that redirects and constricts the soundwave therethrough. In particular, it has been found that a sector-shaped expansion chamber can be employed to significantly reduce the unwanted variations in sound pressure levels along the wavefront exiting the enclosure. Advantageously, the sector-shaped expansion chamber, when coupled with careful design of the remaining aspects of the enclosure, allows for significant uniformity of path lengths for the soundwaves traveling through the enclosure. Also, optionally the exit ports of such an enclosure can be placed side-by-side to combine the outputs into one composite, combined to closely mimic a line source, a single point source, or a converging wavefront.

Optionally, the sector-shaped expansion chamber can be coupled with a second sector-shaped expansion chamber in a back-to-back arrangement to create a generally bowtie-shaped expansion chamber couplet.

In a first example embodiment, a novel sound reproduction system includes a sound enclosure defining a soundwave path therein and having a sound admission portion, a sound emission portion, and sound shape-forming portion positioned therebetween. At least one driver is positioned adjacent the sound admission portion for producing a soundwave. The sound shape-forming portion includes: (1) one or more sector-shaped expansion chambers for expanding the soundwave as it travels therethrough; (2) a baffle restriction portion in communication with the expansion chamber and adapted to constrict the soundwave traveling therethrough to a plurality of narrow, curved slot travel paths generally perpendicular to the expansion chamber(s); and (3) a plurality of alignment chambers in communication with the baffle restriction portion and being generally perpendicular to the curved slot travel paths. Preferably, the sound emission portion has at least one outlet port and is in communication with the alignment chambers and wherein the various portions are dimensioned and configured such that as the soundwave travels through the baffle restriction portion and exits through the outlet port, the soundwave travels along sound paths of substantially uniform length. The substantially uniform sound path lengths allow the sound to be manipulated into behaving substantially as if it emanates from a line sound source (or from a point source much farther distant than from the back plane of the enclosure).

Optionally, the one or more expansion chambers comprises four sub-chambers, each being generally wedge-shaped. Also optionally, the sound shape-forming portion includes a first plurality of redirecting surfaces for redirecting sound waves entering through the inlet port and directing them laterally through the expansion chamber.

Optionally, the sound shape-forming features can be ganged in a single enclosure wherein the enclosure carries multiple drivers, comprises multiple inlet ports and multiple outlet ports. For example, the sound shape-forming portion can further include a second plurality of redirecting surfaces for redirecting sound from the expansion chamber(s) and into narrow, curved slot travel paths generally perpendicular to the expansion chamber(s). Also, the sound shape-forming portion can include a third plurality of redirecting surfaces for redirecting sound from the narrow, curved slot travel paths generally perpendicular to the expansion chamber(s) and toward and into the alignment chambers. Also optionally, the sound shape-forming portion can further include a fourth plurality of redirecting surfaces for redirecting sound from the alignment chambers toward and through the at least one outlet port, and so on.

Preferably, the various portions are dimensioned and configured such that as the soundwave travels through the baffle restriction portion and exits through the at least one outlet port, path lengths of the sound wave are substantially equal, to produce a flat wavefront as if emanating from a line source or a more distant point source.

Optionally, the plurality of alignment chambers can include two sub-chambers, separated by a pair of redirecting surfaces for redirecting sound from the alignment chambers toward and through the at least one outlet port. Also optionally, the at least one outlet port comprises at least two outlet ports, co-aligned with the pair of redirecting surfaces separating the two sub-chambers of the alignment chamber. In one optional form, the at least two outlet ports are substantially rectangular.

In another example form, a system for reproducing sound includes a sound enclosure defining a soundwave path therein and having a sound admission portion, a sound emission portion, and sound shape-forming portion positioned therebetween. At least one driver is placed adjacent the sound admission portion for producing a soundwave. The sound shape-forming portion includes an expansion chamber for expanding the soundwave as it travels therethrough and a baffle restriction portion. The baffle restriction portion is in communication with the expansion chamber and is adapted to constrict the soundwave traveling therethrough to a plurality of narrow, curved slot outlet ports generally perpendicular to the expansion chamber formed in the sound emission portion. Further, the various portions are dimensioned and configured such that as the soundwave travels through the baffle restriction portion and exits through the outlet ports, the soundwave is caused to follow equal-length paths and is thereby manipulated into behaving substantially as if it emanates from a line sound source or a more distant point source.

Optionally, the enclosure carries multiple drivers and comprises multiple inlet ports aligned linearly with one another and multiple narrow, curved outlet ports. Between each inlet port and outlet port are positioned a bowtie-shaped expansion chamber for expanding the soundwave as it travels therethrough and a baffle restriction portion. The baffle restriction portion is in communication with the expansion chamber and IS adapted to constrict the soundwave traveling therethrough to a plurality of narrow, curved slot travel paths generally perpendicular to the bowtie-shaped expansion chamber.

Preferably, the multiple curved outlet ports comprise a first linear row of curved outlet ports and a second linear row of curved outlet ports spaced apart from the first linear row of curved outlet ports. Optionally, a double-sided redirecting element is positioned equidistant between the two spaced apart rows of curved outlet ports and provided for diminishing acoustic interference between sound waves emanating from each of the two spaced apart rows of curved outlet ports.

### BRIEF DESCRIPTION OF THE DRAWING FIGURES

FIG. 1 is a schematic sectional view of a first embodiment of a sound reproduction system illustrating certain aspects of the present invention and depicting layers A-E thereof.

FIGS. 2A-2E are schematic elevational views of layers A-E of the embodiment of FIG. 1, as viewed from direction 2.

FIGS. 3A-3E are schematic elevational views of layers A-E of the embodiment of FIG. 1, as viewed from direction 3.

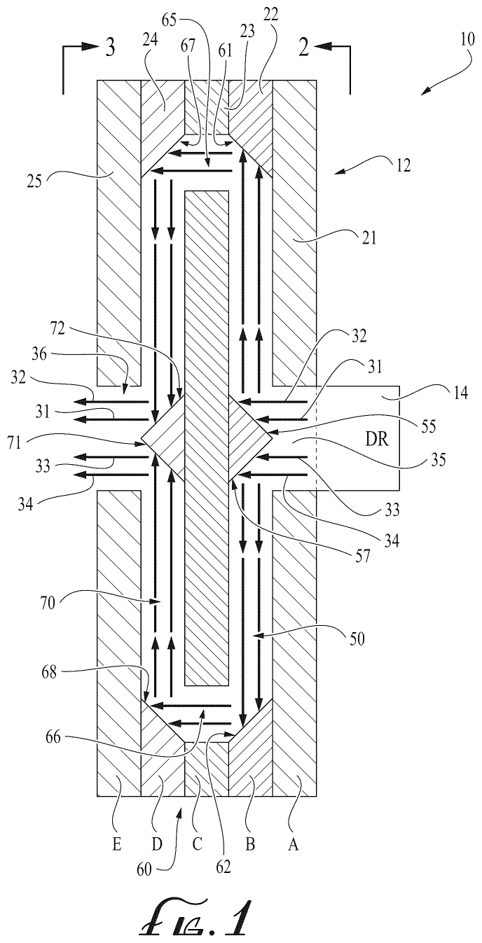

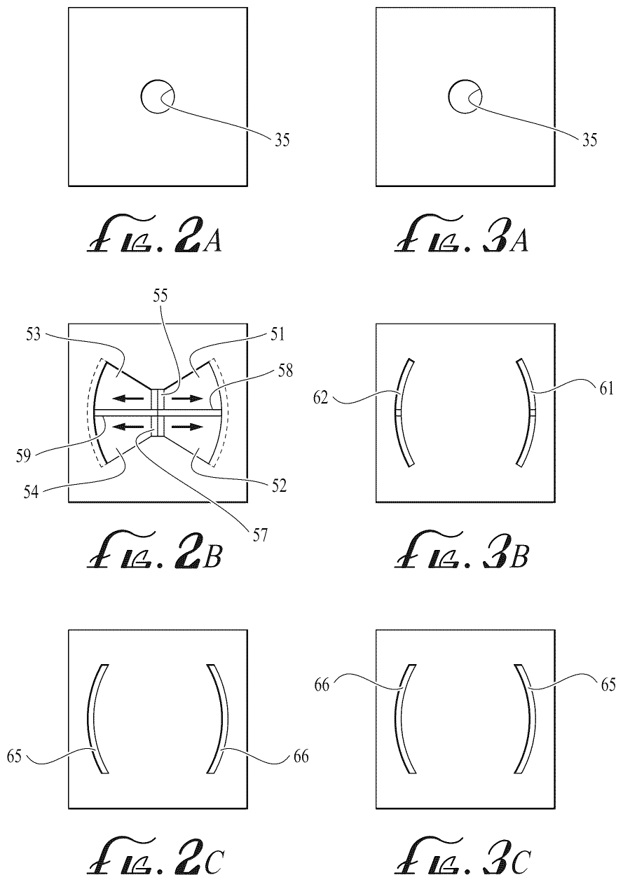

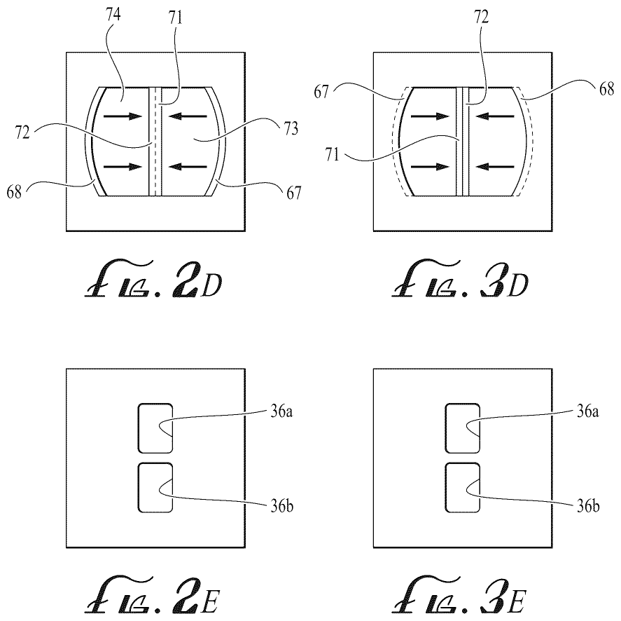

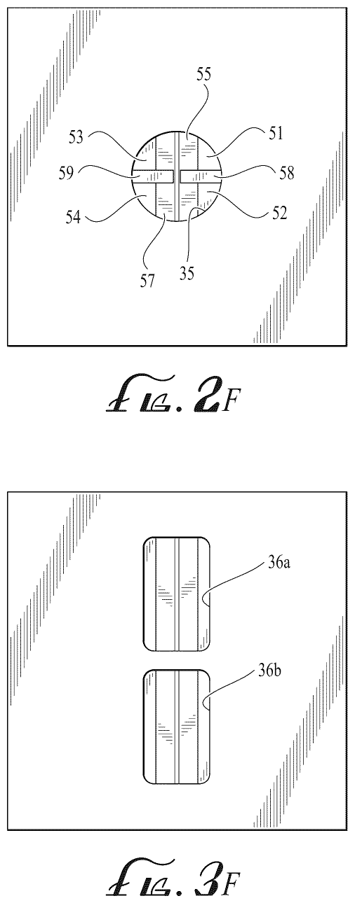

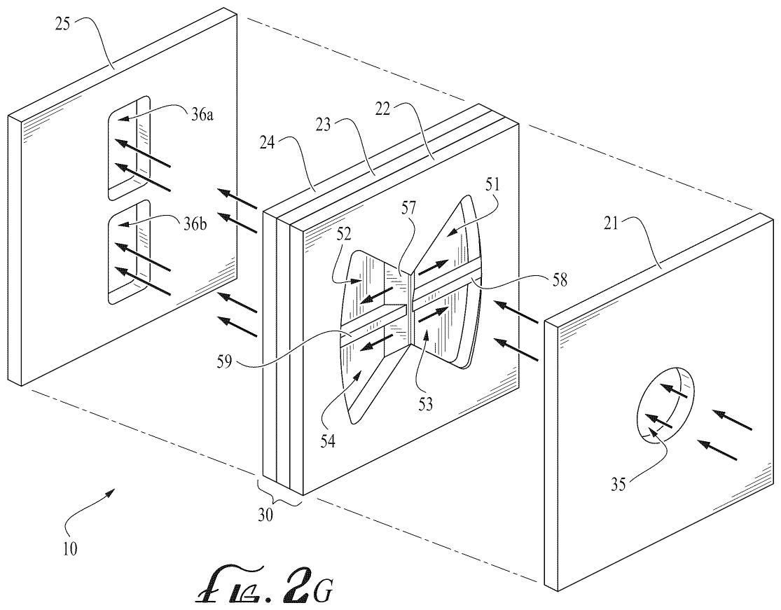

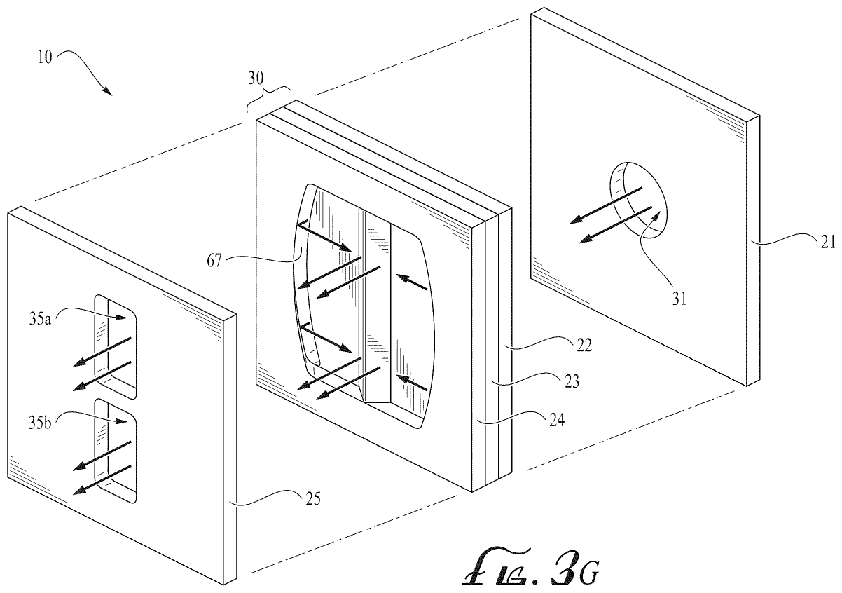

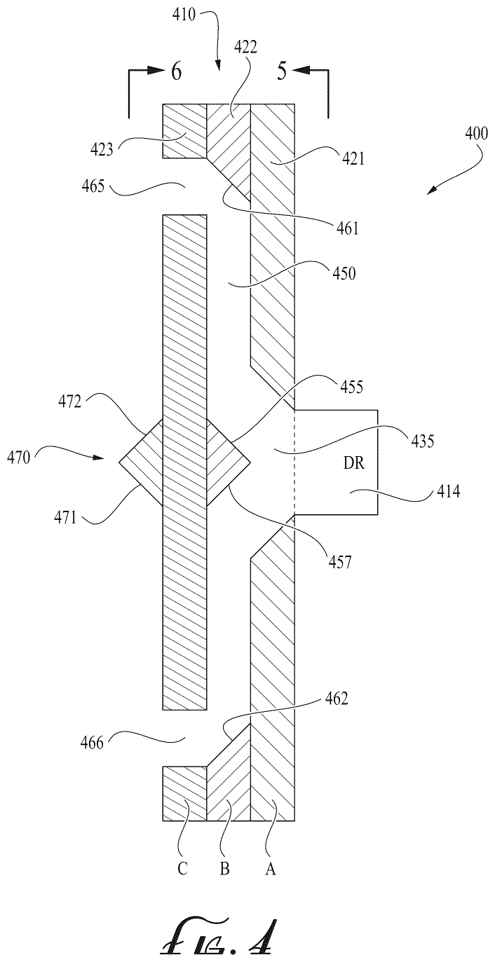

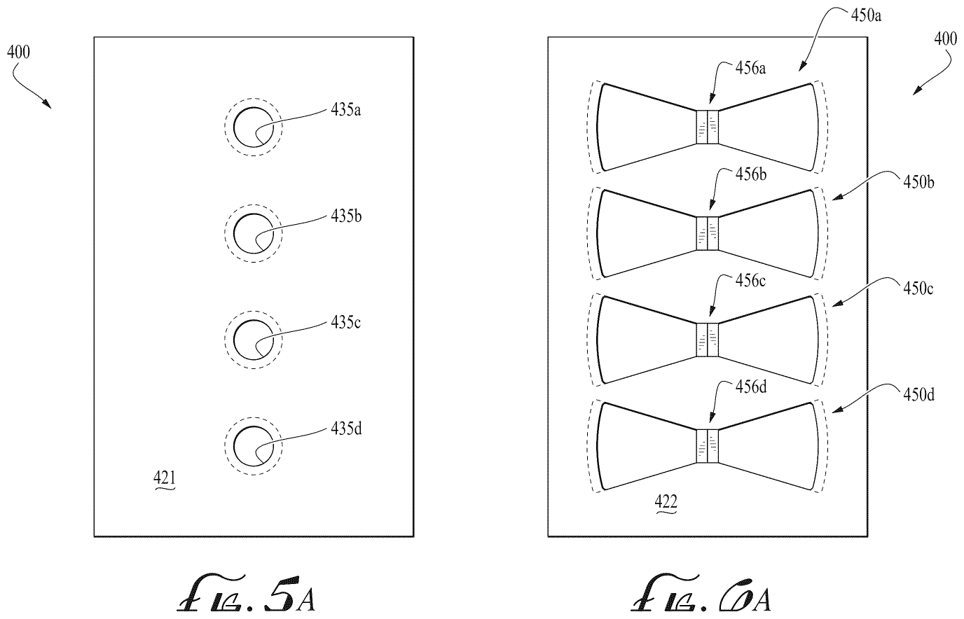

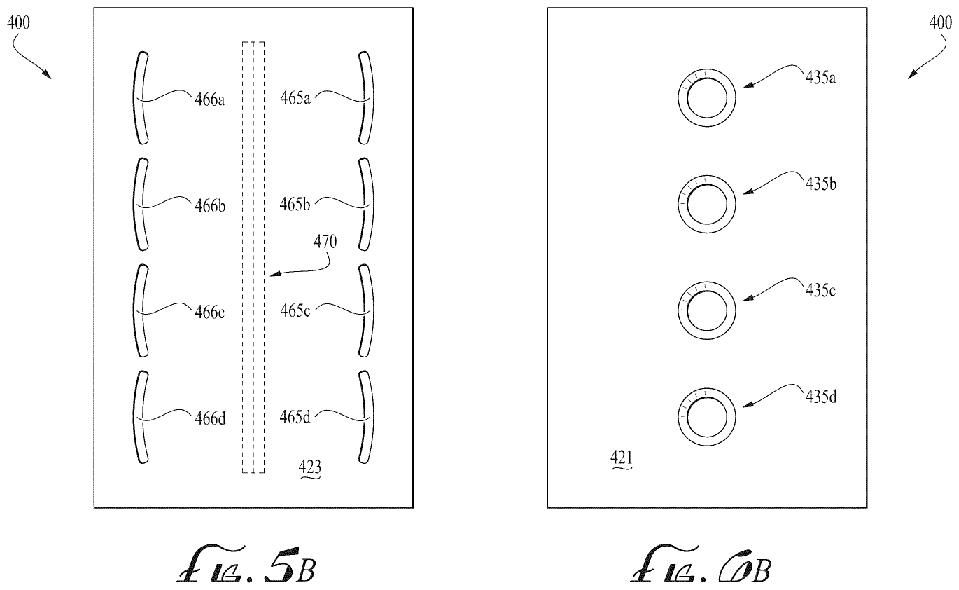

FIG. 2F is a schematic elevational view of the embodiment of FIG. 1, as viewed from direction 2.

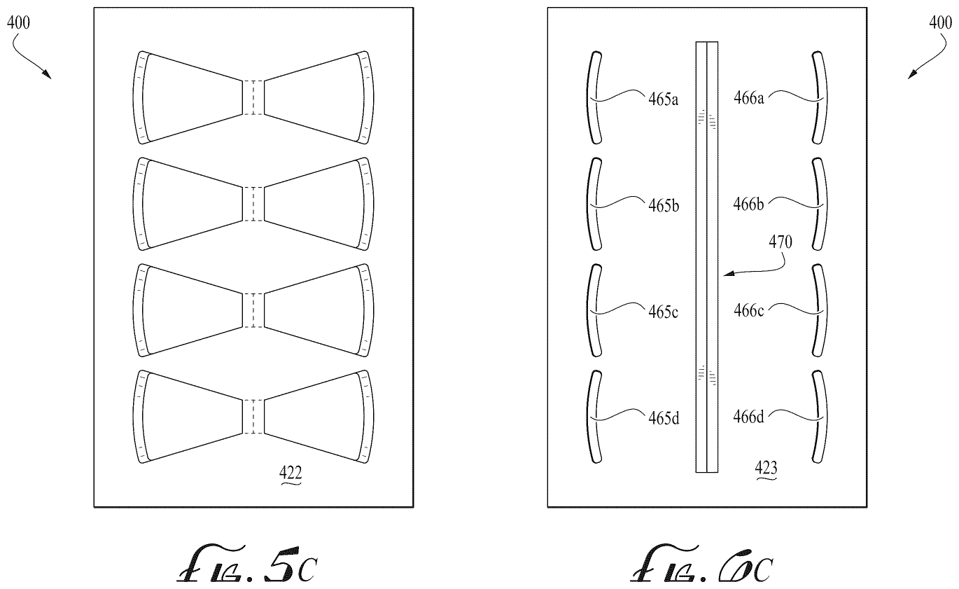

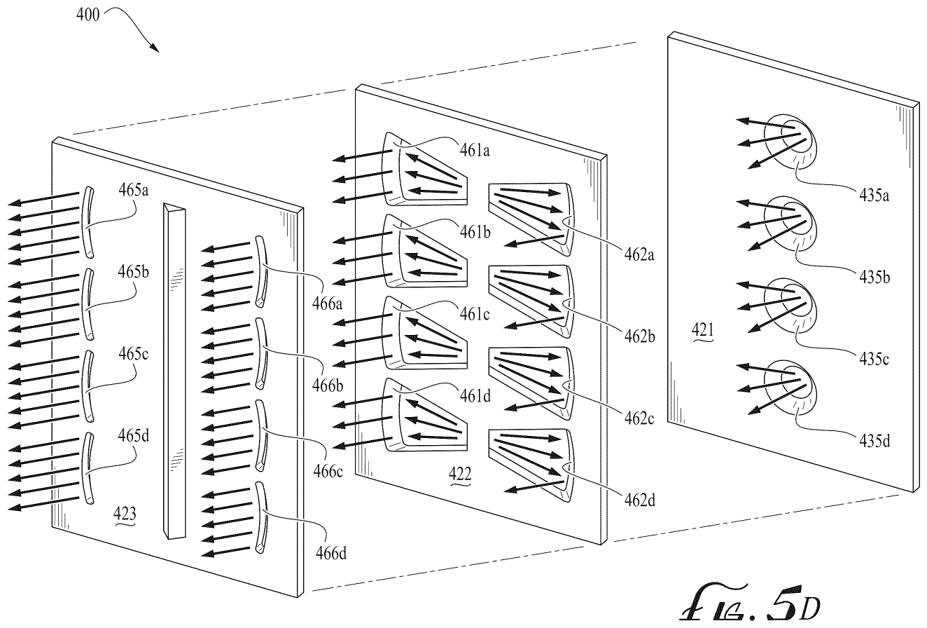

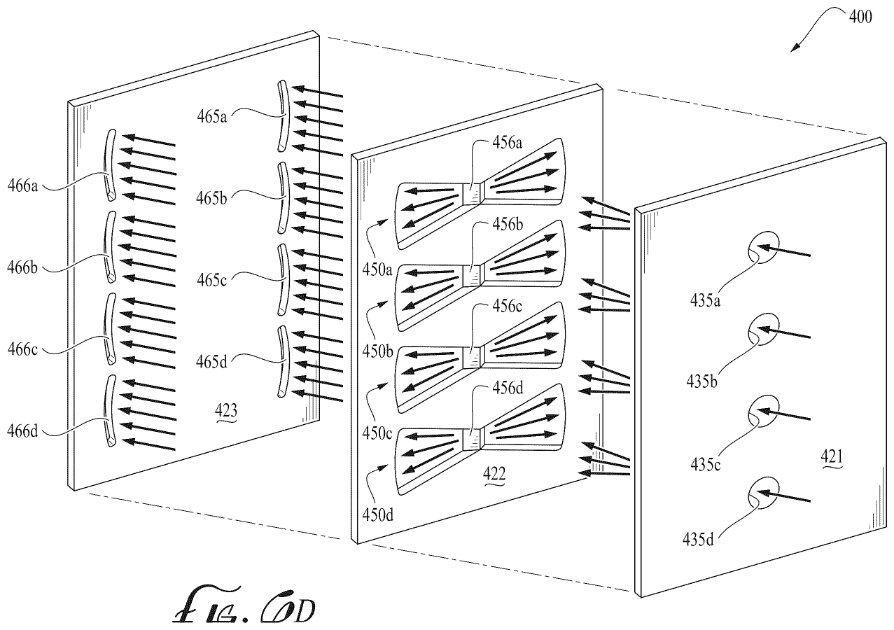

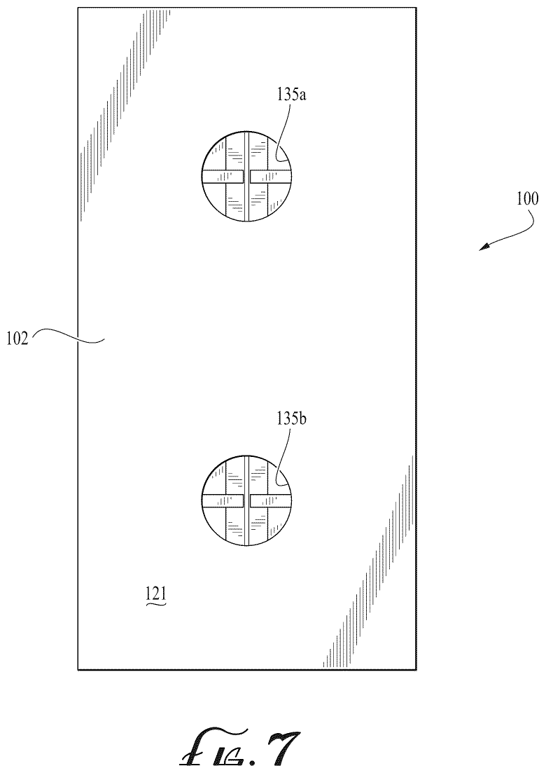

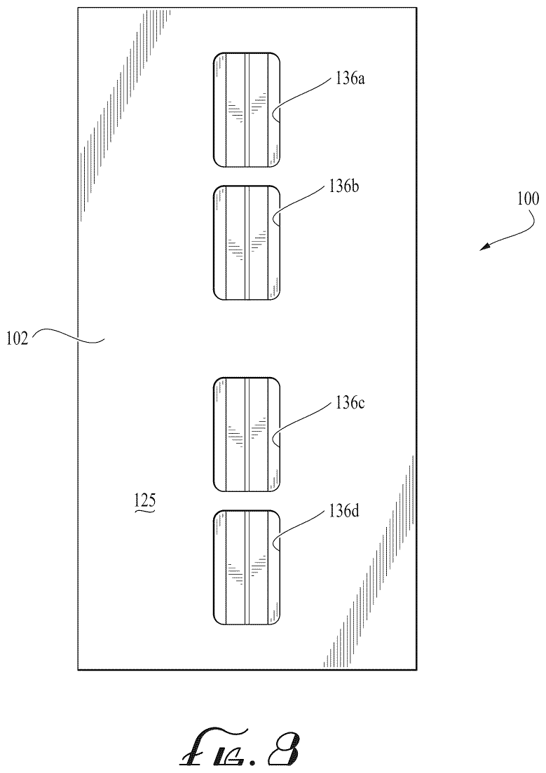

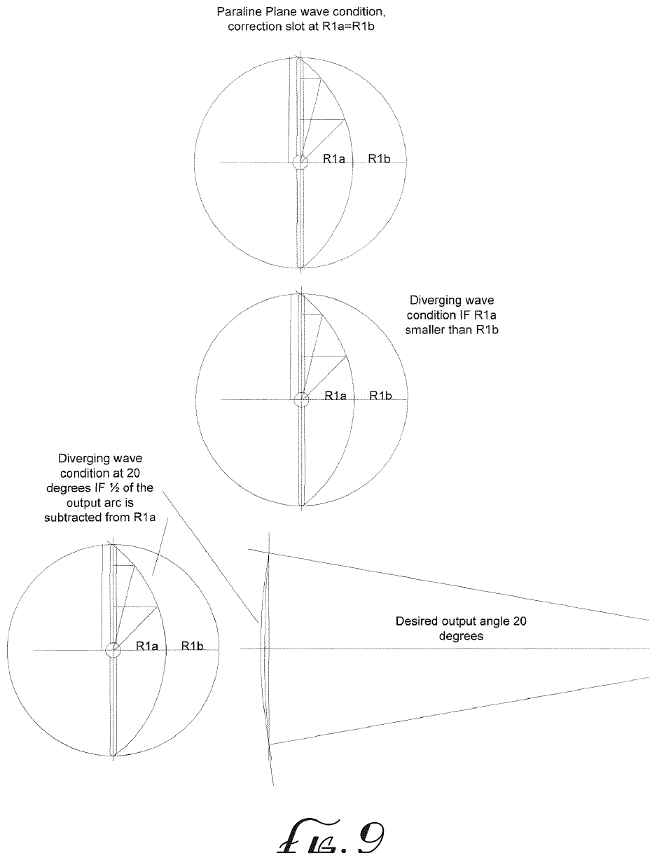

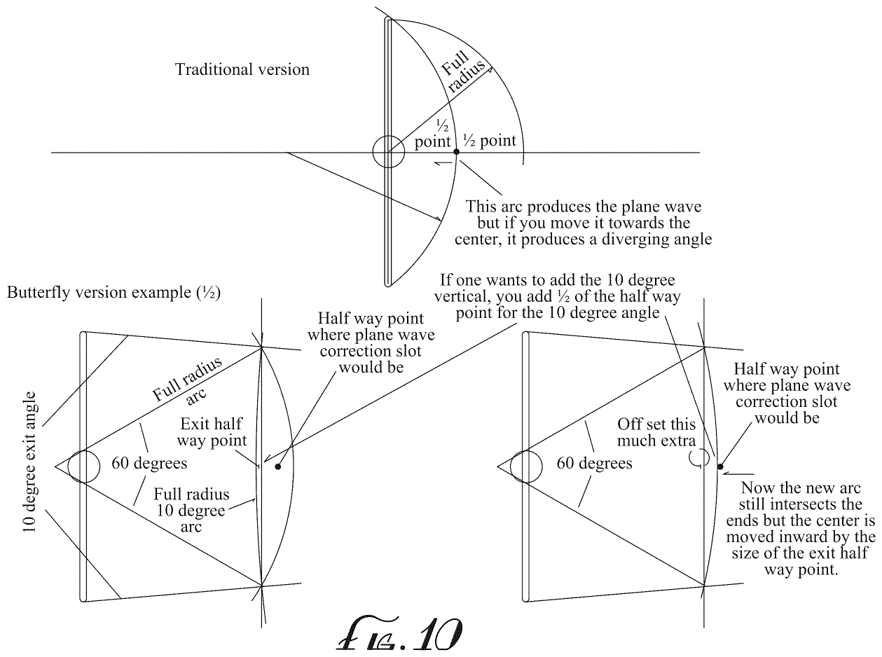

FIG. 3F is a schematic elevational view of the embodiment of FIG. 1, as viewed from direction 3.

FIG. 2G is a schematic, exploded view of the embodiment of FIG. 1, as viewed from direction 2.

FIG. 3G is a schematic, exploded view of the embodiment of FIG. 1, as viewed from direction 3.

FIG. 4 is a schematic sectional view of a second embodiment of a sound reproduction system illustrating certain aspects of the present invention and depicting layers A-C thereof.

FIGS. 5A-5C are schematic elevational views of layers A-C of the embodiment of FIG. 4, as viewed from direction 5. FIG. 5D is a schematic, exploded view of the embodiment of FIG. 4, as viewed from direction 5.

FIGS. 6A-6C are schematic elevational views of layers A-C of the embodiment of FIG. 4, as viewed from direction 6. FIG. 6D is a schematic, exploded view of the embodiment of FIG. 4, as viewed from direction 6.

FIG. 7 is a schematic rear elevational view of another example embodiment, similar to that of FIG. 1, but having multiple inlets and outlets.

FIG. 8 is a schematic front elevational view of the example embodiment of FIG. 7, with multiple inlets and outlets.

FIG. 9 and FIG. 10 are schematic illustrations of geometric adjustments to be made to the construction of bowtie expansion chambers to provide substantially equal sound path lengths through the enclosure.

### DESCRIPTION OF EXAMPLE EMBODIMENTS

The invention disclosed herein is, of course, susceptible of embodiment in many different forms. Shown in the drawings and described herein below in detail are the preferred embodiments of the invention. It is to be understood, however, that the example embodiments of the present disclosure are illustrative of the principles of the invention and the scope of the invention is not to be limited to the illustrative embodiments.

For ease of description, sound reproduction systems embodying the present invention are described herein below in their usual assembled position as shown in the accompanying drawings and terms such as front, rear, upper, lower, horizontal, longitudinal, etc., may be used herein with reference to this usual position. However, the sound reproduction systems may be manufactured, transported, sold, or used in orientations other than that described and shown herein.

Referring now to FIG. 1, wherein like parts are represented by like reference numerals throughout the several views, a sound reproduction system 10 embodying certain aspects of the present invention is shown in the figures, beginning with FIG. 1. Included is an enclosure generally indicated at 12 to provide acoustic loading for the output of a driver 14 (also labeled “DR” for clarity). In the preferred embodiment, enclosure 12 is constructed by joining a stack of layers together. See layers 21-25, also labeled as layers A-E for easy reference to other figures, as will be more plain below. Included are outer layers 21 and 25, as well as a sound shape forming section or portion comprising layers 22, 23, 24. The various layers cooperate to form expansion and alignment chambers near the inlet and exit portions of the enclosure.

Enclosure 12 preferably comprises a folded horn that defines a pathway or passageway for the soundwave emanating from driver 14. The cross-sectional area of the folded horn is constantly expanding as the sound travels therethrough, although the shape of the folded horn is novel and unconventional. As will be seen herein, the pathway defined by the horn enclosure includes a number of features including bends and/or redirecting surfaces in the soundwave path.

The enclosure of the first example embodiment forces the soundwave to bend or redirect or change directions multiple times as it travels toward the enclosure exit. In forcing the soundwave through the enclosure, the travel length for the soundwave is substantially the same regardless of where within the internal pathways the soundwave travels. For example, consider a first pathway as depicted by arrows labeled 31. Now consider a second pathway as depicted by arrows labeled 32. The lengths of these two pathways 31 and 32 are equal to one another, despite the fact that soundwaves generally proceed as a spherical wavefront. Similarly, the lengths of pathways 33 and 34 are equal to one another. Furthermore, all four of these pathways (31, 32, 33, and 34) are all of equal length. This allows the sound emanating as a soundwave through the front of the enclosure 12 to appear as a single soundwave, in-phase. In this way, the sound emanating as a soundwave through the front of the enclosure behaves as if it emanates from a line source or a more distant point source.

The enclosure 12 preferably is provided with redirecting surfaces to guide the soundwave through the enclosure while minimizing constructive or destructive interference within the enclosure.

In the first example embodiment, a novel sound reproduction system includes a sound enclosure 12 defining a soundwave path therein and having a sound admission portion, a sound emission portion, and sound shape-forming portion positioned therebetween. As best seen initially in FIGS. 2G and 3G, the sound admission portion comprises outer layer 21 and has a cylindrical inlet port 35. In these figures, the driver is omitted for clarity of illustration. Furthermore, the driver can be provided as a separate element. The sound emission portion comprises outer layer 25 and has generally rectangular outlet ports 36a and 36b with rounded corners. The sound shape-forming portion 30 is positioned between the outer layers 21 and 25 and comprises layers 22, 23, and 24.

At least one driver 14 is positioned adjacent the sound admission portion for producing a soundwave (see FIG. 1). The sound shape-forming portion includes: (1) a bowtie-shaped expansion chamber 50 for expanding the soundwave as it travels therethrough; (2) a baffle restriction portion 60 in communication with the expansion chamber and adapted to constrict the soundwave traveling therethrough to a plurality of narrow, curved slot travel paths generally perpendicular to the bowtie-shaped expansion chamber; and (3) a plurality of alignment chambers 70 in communication with the baffle restriction portion 60 and being generally perpendicular to the curved slot travel paths.

Preferably, the sound emission portion 25 has at least one outlet port 36 (as shown in FIGS. 1, 2A, 2B) and is in communication with the alignment chambers 70 and wherein the various portions are dimensioned and configured such that as the soundwave travels through the baffle restriction portion 60 and exits through the outlet port 35, the soundwave is manipulated into behaving substantially as if it emanates from a line sound source. In this regard, the novel sound enclosure can be thought of as a “paraline” sound enclosure.

The bowtie-shaped expansion chambers allow the expanding wavefront to reach the redirecting surfaces at the same time (because the redirecting surfaces are equidistant from the source along their curved lengths). The soundwave thus is forced through the slots substantially in time phase as if from a point source. The sound then is “compressed” or “focused” or aligned in the alignment chambers, much as if it were light bouncing off of a curved mirror (although this analogy is not purely correct from a physics standpoint). It then arrives at redirecting surfaces 71, 72 substantially as if emanating from a line source and proceeds out through the outlet ports 36a, 36b, again as if from a line source. Of course, from there, the wavefront can begin to expand unimpeded by the sound-shaping enclosure. But in this way, the sound-shaping enclosure 12 allows a point source driver to be used to produce a line-source-like output. Or stated another way, the sound-shaping enclosure 12 allows a point source driver to be used to produce a much flatter sound pressure wave, as if the point source were positioned far to the rear of the enclosure, without the concomitant sound level losses that would otherwise attend positioning the driver far to the rear of the enclosure front surface.

Optionally, the bowtie-shaped expansion chamber 50 comprises four sub-chambers 51-54, each being generally wedge-shaped (see FIGS. 2B, 2F, and 2G). Also optionally, the sound shape-forming portion 30 includes a first plurality of redirecting surfaces 55, 57 for redirecting sound waves entering through the inlet port and directing them laterally through the sub-chambers 51-54. A pair of lateral dividers 58, 59 extend from the center of the bowtie-shaped chamber 50 and help define the four sub-chambers 51-54.

The sound shape-forming portion can further include a second plurality of redirecting surfaces 61, 62 for redirecting sound from the bowtie-shaped expansion chamber and into narrow, curved slot travel paths 65, 66 generally perpendicular to the bowtie-shaped expansion chamber 50. Also, the sound shape-forming portion can include a third plurality of redirecting surfaces 67, 68 for redirecting sound from the narrow, curved slot travel paths 65, 66 generally perpendicular to the bowtie-shaped expansion chamber and toward and into the alignment chambers 70. Also optionally, the sound shape-forming portion can further include a fourth plurality of redirecting surfaces 71, 72 for redirecting sound from the alignment chambers 70 toward and through the at least one outlet port 35. The alignment chambers 70 have a curved surface which operates to “focus” the sound linearly and ensures that the sound arrives at the exit as if emanating from a line source or a distant point source.

Preferably, the various portions are dimensioned and configured such that as the soundwave travels through the baffle restriction portion and exits through the at least one outlet port, path lengths of the sound wave are substantially equal, to produce a flat wavefront as if emanating from a line source or a distant point source.

Optionally, the curved or arcuate portions of the bowtie-shaped expansion chambers and the curved or arcuate portions of the alignment chambers are circular arcs. However, those skilled in the art will recognize that other shapes can be employed for the same sort of expansion and compression to ensure that the sound paths are all of the same length within the enclosure. For example, elliptical curves could be employed. Similarly, multi-faceted flat surfaces could be used, arranged in a curved manner (although probably not as efficient as a true circular arc would be).

Optionally, the plurality of alignment chambers can include two sub-chambers 73, 74, separated by a pair of redirecting surfaces for redirecting sound from the alignment chambers toward and through the at least one outlet port. Also optionally, the at least one outlet port comprises at least two outlet ports, co-aligned with the pair of redirecting surfaces separating the two sub-chambers of the alignment chamber. In one optional form, the outlet ports are substantially rectangular.

Optionally, the sound shape-forming features can be ganged in a single enclosure wherein the enclosure carries multiple drivers, comprises multiple inlet ports and multiple outlet ports. For example, looking at FIG. 3F, one can see that the two outlet ports 36a and 36b are taller than they are wide and are vertically aligned with one another. The paraline output emanating from the two outlet ports behaves much like a line source. This effect can be extended by stacking another such arrangement vertically, such that four outlet ports are arranged in a vertical line (with two sets of wave shape-forming structures behind the pairs of outlet ports and two drivers providing sound wave inputs to two inlet ports.

FIG. 7 is schematic rear elevational view of another example embodiment, similar to that of FIG. 1, but having multiple inlets and outlets and multiple wave shape-forming structures between the pair of inlet ports and the pairs of outlet ports (the drivers are omitted from this figure for clarity of illustration). FIG. 8 is schematic front elevational view of the example embodiment of FIG. 7, with multiple inlets and outlets.

As shown in FIGS. 7 and 8, a ganged sound reproduction system 100 embodying certain aspects of the present invention is shown in the figures, including an enclosure generally indicated at 102 to provide acoustic loading for the output of a pair of drivers. Just as in the embodiment of FIGS. 1-3F, enclosure 102 is constructed by joining a stack of layers together. Included are outer layers 121 and 125, as well as sound shape forming section or portion therebetween. The various layers cooperate to form expansion and alignment chambers near the inlet and exit portions of the enclosure.

The sound shape-forming portion includes: (1) bowtie-shaped expansion chambers for expanding the soundwave as it travels therethrough; (2) baffle restriction portions in communication with the expansion chambers and adapted to constrict the soundwaves traveling therethrough to a plurality of narrow, curved slot travel paths generally perpendicular to the bowtie-shaped expansion chambers; and (3) a plurality of alignment chambers in communication with the baffle restriction portions and being generally perpendicular to the curved slot travel paths.

Preferably, the sound emission portion 125 has four outlet port 136a, 136b, 136c, 136d and are in communication with the alignment chambers and wherein the various portions are dimensioned and configured such that as the soundwaves travel through the baffle restriction portions and exits through the outlet ports, the soundwaves are manipulated into behaving substantially as if they emanate from a line sound source.

In another example form shown in FIGS. 4-6D, a ganged system 400 for reproducing sound is provided and includes a sound enclosure 410 defining a plurality of soundwave paths therein and having a sound admission portion 421, a sound emission portion 423, and sound shape-forming portion 422 positioned therebetween. A plurality of drivers, such as driver 414, are placed adjacent the sound admission portion 421 for producing soundwaves. Notably, in the embodiment of FIGS. 1-3G, the soundwaves are folded or turned or redirected four times as they travel from the inlet port to the outlet port, while in the embodiment shown in FIGS. 4-6D, the sound waves are folded or turned or redirected only twice as they travel from the inlet port to the outlet port. Another difference between the two examples is that in the first embodiment, the sound emanates from each rectangular port more or less linearly, as if from a line source. In this current embodiment, the sound emanates from short, curved outlet ports. The output from each individual outlet port, by itself, is not exactly like from a line source. But since these outlet ports are close together and aligned with one another in a line, the resulting composite output of the group of outlet ports is very much as if it were emanating from line source.

In the ganged system just described, the inlets and the drivers are aligned linearly. On the other hand, optionally, the inlets and drivers can be laterally staggered, to allow more drivers to be provided while keeping the size of the enclosure as small as possible.

The sound shape-forming portion 422 includes bowtie-shaped expansion chambers for expanding the soundwave as it travels therethrough and a baffle restriction portion. As shown in FIG. 4, the bowtie-shaped expansion chamber is item 450. However, as shown in FIG. 6D, there are multiple such bowtie-shaped expansion chambers. In this example, there are four such bowtie-shaped expansion chambers 450a, 450b, 450c, and 450d. It will be appreciated that fewer or greater numbers of such bowtie-shaped expansion chambers can be used, as desired. Similarly, there are four corresponding frusto-conical inlet ports 435a, 435b, 435c, and 435d. The four bowtie-shaped expansion chambers 450a, 450b, 450c, and 450d each include a double-sided redirector 456a, 456b, 456c, and 456d.

The sound shape-forming portion includes a second plurality of redirecting surfaces 461a-461d, 462a-462d for redirecting sound from the bowtie-shaped expansion chambers and into the array of narrow, curved slots 465a-465d and 466a-466d generally perpendicular to the bowtie-shaped expansion chambers.

The baffle restriction portion is in communication with the expansion chambers and is adapted to constrict the soundwave traveling therethrough to a plurality of narrow, curved slot outlet ports generally perpendicular to the bowtie-shaped expansion chambers formed in the sound emission portion. Further, the various portions are dimensioned and configured such that as the soundwave travels through the baffle restriction portion and exits through the outlet ports, the soundwave is manipulated into behaving substantially as if it emanates from a line sound source, particularly taking advantage of the linear ganged arrays of curved outlet ports.

Preferably, the multiple curved outlet ports 465a-465d comprise a first linear row of curved outlet ports and the second linear row of curved outlet ports 466a-466d spaced apart from the first linear row of curved outlet ports. Optionally, a double-sided redirector 470, having redirecting surfaces 471 and 472, is positioned equidistant between the two spaced apart rows of curved outlet ports and is provided for diminishing acoustic interference between sound waves emanating the two spaced apart rows of curved outlet ports.

The present invention, in one aspect, finds application in the field of line sources. Line sources are a type of acoustic source which is acoustically large in one dimension but acoustically small in the other. An elongated ribbon driver is an example of this type of arrangement. Ribbon sources radiate in an expanding cylindrical pattern, with a planar wave in the vertical and wide in the horizontal. Here, the sound is produced across its entire height, over the entire frequency range simultaneously and as a result of the large acoustic source size, large enough to produce directivity. This radiates more like a cylindrical shape wave as opposed to a spherical wavefront. In the line source case, the sound pressure falls off more slowly with distance, (ideally, if the source were infinitely long), at half the rate compared to a point source, where the sound travels away in a spherical pattern. For the point source, the energy density at a given distance (at the surface of the expanding sphere) is found to fall at the inverse square law, the sound pressure level falls 6 dB or a factor of four in power for each doubling of the distance.

The design configuration shown in FIG. 1 introduces a particular loading on driver 14, such that the driver 14 can be realized as a point source utilizing a cone diaphragm, for example, but still produce output with a substantially flat, planar wavefront. The enclosure design indicated in FIG. 1 is, in one embodiment, realized in a horn enclosure.

In one embodiment, the shape and flow constriction is provided by an internal baffle plate with a correction slot that forces the soundwave traveling along within the enclosure, through an expanding passage sized with acoustic dimensions that are small enough so that the sound can bend or direct around corners without interference.

According to one principle of the present invention, the curvature of slotted opening and/or redirecting surfaces is chosen such that all of the paths have substantially the same length from the input to the output of the enclosure.

Design configurations according to principles of the present invention adjust the path length (in time or space) of a soundwave traveling through the enclosure, so that the sound pressure from the particular driver employed is constrained to follow a predefined pattern. For example, when a planar wavefront is desired, all portions of sound pressure from the driver are constrained to follow an identical time or space path length to any point at the exit slot. In one aspect, this is accomplished with an expanding cross section horn whose dimension in one plane is small enough to be folded with little or no loss up to the highest frequency of interest. The thickness of the pathways generally defines the upper limit of the wavelength (and thus frequency) that can be effectively transmitted through the enclosure. With a pathway thickness of about 3/16 inch to ¼ inch, the quarter wavelength “reflection” resulting in half wavelength destructive interference, the max frequency that can be passed through the enclosure would be about 18 kHz. Fortunately, this is about where human hearing drops off for all but a small percentage of people. Thus, one advantageous thickness for the acoustic pathway is about 3/16 inch to about ¼ inch.

In one embodiment, the layers of the enclosure are formed from plywood panels having a preferred nominal thickness of about 3/16 to ¾ inches. While plywood works well, other materials can be employed. For example, polymer panels could be employed. Optionally, the nominal thickness of the plywood panels can be about 3/16 inch to about one half an inch. The relatively smaller, lateral dimension of slotted openings corresponds roughly to this panel thickness. The openings in other layers are scaled accordingly, as illustrated. Other arrangements are, of course, possible. The layers are preferably securely fastened together to prevent unwanted energy absorption, rattles, noises, etc. If desired, other numbers of layers may be employed.

FIG. 9 and FIG. 10 are schematic illustrations of geometric adjustments to be made to the construction of bowtie expansion chambers to provide substantially equal sound path lengths through the enclosure.

While the invention has been described and shown in preferred illustrative forms, those skilled in the art will recognize that many modifications, additions, and deletions may be made therein without departing from the spirit and scope of the invention as set out in the following claims.

What is claimed is:

1. A system for reproducing sound, comprising:
a sound enclosure defining a soundwave path therein and having a sound admission portion, a sound emission portion, and sound shape-forming portion positioned therebetween;
at least one driver adjacent the sound admission portion for producing a soundwave;
the sound shape-forming portion including
an expansion chamber for expanding the soundwave as it travels therethrough;
a baffle restriction portion in communication with the expansion chamber and adapted to constrict the soundwave traveling therethrough to a plurality of narrow, curved slot travel paths generally perpendicular to the expansion chamber;
a plurality of alignment chambers in communication with the baffle restriction portion and being generally perpendicular to the curved slot travel paths; and
wherein the sound emission portion has at least one outlet port and is in communication with the alignment chambers and wherein the various portions are dimensioned and configured such that as the soundwave travels through the baffle restriction portion and exits through the outlet port, the soundwave travels along paths of uniform length and thus is manipulated into behaving substantially as if it emanates from a line sound source or a more distant point source.

2. The system according to claim 1 wherein the expansion chamber is bow-tie shaped and comprises four sub-chambers, each being generally wedge-shaped.

3. The system according to claim 2 wherein the sound shape-forming portion includes a first plurality of redirecting surfaces for redirecting sound waves entering through the inlet port and directing them laterally through the bowtie-shaped expansion chamber.

4. The system according to claim 3 wherein the sound shape-forming portion further includes a second plurality of redirecting surfaces for redirecting sound from the bowtie-shaped expansion chamber and into narrow, curved slot travel paths generally perpendicular to the bowtie-shaped expansion chamber.

5. The system according to claim 4 wherein the sound shape-forming portion further includes a third plurality of redirecting surfaces for redirecting sound from the narrow, curved slot travel paths generally perpendicular to the bowtie-shaped expansion chamber and toward and into the alignment chambers.

6. The system according to claim 5 wherein the sound shape-forming portion further includes a fourth plurality of redirecting surfaces for redirecting sound from the alignment chambers toward and through the at least one outlet port.

7. The system according to claim 1 wherein the various portions are dimensioned and configured such that as the soundwave travels through the baffle restriction portion and exits through the at least one outlet port path lengths are substantially equal, to produce a flat wavefront as if emanating from a line source or a more distant point source.

8. The system according to claim 1 wherein the plurality of alignment chambers comprises two sub-chambers, separated by a pair of redirecting surfaces for redirecting sound from the alignment chambers toward and through the at least one outlet port.

9. The system according to claim 8 wherein the at least one outlet port comprises at least two outlet ports, co-aligned with the pair of redirecting surfaces separating the two sub-chambers of the alignment chamber.

10. The system according to claim 9 wherein the at least two outlet ports are substantially rectangular.

11. The system according to claim 1 wherein the sound waves are generated by a single driver.

12. The system according to claim 1 wherein the expansion chamber comprises one or more generally sector-shaped chambers.

13. The system according to claim 12 wherein at least two generally sector-shaped chambers are arranged back-to-back to form a bowtie-shaped couplet expansion chamber.

14. The system according to claim 1 wherein the enclosure carries multiple drivers, comprises multiple inlet ports and multiple outlet ports, and
wherein between each inlet port and outlet port are positioned:
a bowtie-shaped expansion chamber for expanding the soundwave as it travels therethrough;
a baffle restriction portion in communication with the expansion chamber and adapted to constrict the soundwave traveling therethrough to a plurality of narrow, curved slot travel paths generally perpendicular to the bowtie-shaped expansion chamber; and
a plurality of alignment chambers in communication with the baffle restriction portion and being generally perpendicular to the curved slot travel paths.

15. A system for reproducing sound, comprising:
a sound enclosure defining a soundwave path therein and having a sound admission portion, a sound emission portion, and sound shape-forming portion positioned therebetween;
at least one driver adjacent the sound admission portion for producing a soundwave;
the sound shape-forming portion including
one or more sector-shaped expansion chambers for expanding the soundwave as it travels therethrough; and
a baffle restriction portion in communication with the expansion chamber(s) and adapted to constrict the soundwave traveling therethrough to a plurality of narrow, curved slot outlet ports generally perpendicular to the expansion chamber(s) formed in the sound emission portion, and wherein the various portions are dimensioned and configured such that as the soundwave travels through the baffle restriction portion and exits through the outlet ports, the soundwave is manipulated into behaving substantially as if it emanates from a line sound source or as a more distant point source.

16. The system according to claim 14 wherein the enclosure carries multiple drivers, comprises multiple inlet ports aligned linearly with one another and multiple narrow, curved outlet ports, and
wherein between each inlet port and outlet port are positioned:
an expansion chamber for expanding the soundwave as it travels therethrough; and
a baffle restriction portion in communication with the expansion chamber and adapted to constrict the soundwave traveling therethrough to a plurality of narrow, curved slot travel paths generally perpendicular to the expansion chamber.

17. The system according to claim 16 wherein the multiple curved outlet ports comprise a first linear row of curved outlet ports and a second linear row of curved outlet ports spaced apart from the first linear row of curved outlet ports.

18. The system according to claim 17 further comprising a double-sided redirecting element positioned equidistant between the two spaced apart rows of curved outlet ports and provided for diminishing acoustic interference between sound waves emanating from each of the two spaced apart rows of curved outlet ports.
